(19) United States
(12) Patent Application Publication
(10) Pub. No.: US 2026/0319433 A1
(43) Pub. Date: Oct. 15, 2026

(54) PUMP UNIT AND AIR SUPPLY DEVICE

(71) Applicant: CANON KABUSHIKI KAISHA, Tokyo (JP)

(72) Inventor: KEI HAYASHIDA, Tokyo (JP)

(21) Appl. No.: 19/716,793

(22) Filed: Jun. 23, 2026

Related U.S. Application Data
(63) Continuation of application No. 19/044,973, filed on Feb. 4, 2025.

(30) Foreign Application Priority Data
Feb. 27, 2024 (JP) 2024-027891

(51) Int. Cl. G03G 21/20; F04B 9/12; F04B 23/04; F04B 43/02; G03G 15/08; G03G 21/00; G03G 21/18

(52) U.S. Cl. CPC G03G 21/206; F04B 9/12; F04B 23/04; F04B 43/02; G03G 15/0891; G03G 21/0052; G03G 21/1857; G03G 2221/1645; G03G 2221/1657

(57) ABSTRACT

A pump unit includes a motor including a rotation shaft configured to rotate about a rotational axis, a first pump and a second pump, a first drive transmission portion configured to be transitioned between a first transmission state and a first non-transmission state, and a second drive transmission portion configured to be transitioned between a second transmission state and a second non-transmission state. The first drive transmission portion is configured to drive the first pump by being transitioned to the first transmission state, and configured not to drive the first pump by being transitioned to the first non-transmission state. The second drive transmission portion is configured not to drive the second pump by being transitioned to the second non-transmission state, and configured to drive the second pump by being transitioned to the second transmission state.

### BACKGROUND OF THE INVENTION

### Field of the Invention

The present invention relates to a pump unit and an air supply device for conveying air using a pump.

### Description of the Related Art

Hitherto, an image forming apparatus in which is installed a cartridge equipped with a developing container that accommodates toner and an attachment portion capable of having a supply pack accommodating toner attached thereto is proposed (refer to Japanese Patent Application Laid-Open Publication No. 2023-134401). Toner discharged from the supply pack attached to the attachment portion is accommodated temporarily in a reserve tank disposed on a cartridge, and conveyed from the reserve tank to the developing container. Toner is conveyed from the reserve tank to the developing container by a screw or air flowing by a pump.

### SUMMARY OF THE INVENTION

According to a first aspect of the present invention, a pump unit includes a motor including a rotation shaft configured to rotate about a rotational axis in a first rotation direction and in a second rotation direction opposite to the first rotation direction, the rotation shaft including a first end portion on one side of the rotation shaft and a second end portion on the other side of the rotation shaft in a direction of the rotational axis, a first pump and a second pump that are configured to send out air, a first drive transmission portion configured to be transitioned between a first transmission state in which a first driving force is transmitted from the first end portion of the rotation shaft to the first pump and a first non-transmission state in which the first driving force is not transmitted from the first end portion to the first pump, and a second drive transmission portion configured to be transitioned between a second transmission state in which a second driving force is transmitted from the second end portion of the rotation shaft to the second pump and a second non-transmission state in which the second driving force is not transmitted from the second end portion to the second pump. The first drive transmission portion is configured to drive the first pump by being transitioned to the first transmission state when the rotation shaft rotates in the first rotation direction, and configured not to drive the first pump by being transitioned to the first non-transmission state when the rotation shaft rotates in the second rotation direction. The second drive transmission portion is configured not to drive the second pump by being transitioned to the second non-transmission state when the rotation shaft rotates in the first rotation direction, and configured to drive the second pump by being transitioned to the second transmission state when the rotation shaft rotates in the second rotation direction.

According to a second aspect of the present invention, an air supply device for conveying toner in an image forming apparatus includes a motor including (i) a housing, and (ii) first and second shaft portions which are rotatable together about a rotational axis in a first rotation direction and a second rotation direction opposite to the first rotation direction, and which extend in opposite directions with each other with respect to the housing in a direction of the rotational axis, first and second air supply unit configured to supply air, a first clutch configured to transmit a first driving force from the first shaft portion to the first air supply unit when the motor is rotated in the first rotation direction, and configured not to transmit the first driving force from the first shaft portion to the first air supply unit when the motor is rotated in the second rotation direction, and a second clutch configured to transmit a second driving force from the second shaft portion to the second air supply unit when the motor is rotated in the second rotation direction, and configured not to transmit the second driving force from the second shaft portion to the second air supply unit when the motor is rotated in the first rotation direction.

According to a third aspect of the present invention, an air supply device for conveying toner in an image forming apparatus includes a motor including (i) a housing, and (ii) first and second shaft portions which are rotatable together about a rotational axis in a first rotation direction and a second rotation direction opposite to the first rotation direction, and which extend in opposite directions with each other with respect to the housing in a direction of the rotational axis, first and second air supply unit configured to supply air, a first clutch configured to be transitioned between a first transmission state in which a first driving force is transmitted from the first shaft portion to the first air supply unit, and a first non-transmission state in which the first driving force is not transmitted from the first shaft portion to the first air supply unit, and a second clutch configured to be transitioned between a second transmission state in which a second driving force is transmitted from the second shaft portion to the second air supply unit, and a second non-transmission state in which the second driving force is not transmitted from the second shaft portion to the second air supply unit.

Further features of the present invention will become apparent from the following description of exemplary embodiments with reference to the attached drawings.

### BRIEF DESCRIPTION OF THE DRAWINGS

FIG. 1 is a perspective view of a pump unit according to the present embodiment.

FIG. 2A is a plan view of the pump unit.

FIG. 2B is a plan view of the pump unit having a first pipe, a second pipe, a third pipe, and a fourth pipe described below removed therefrom.

FIG. 2C is a front view of the pump unit.

FIG. 3 is an exploded perspective view of the pump unit.

FIG. 4A is a plan view of a fourth clutch portion in a transmission state.

FIG. 4B is a plan view of the fourth clutch portion in a non-transmission state.

FIG. 5A is a cross-sectional view of a 5A-5A cross-section of FIG. 2.

FIG. 5B is a cross-sectional view of a first pump illustrating a state in which a first eccentric shaft has been rotated for 90 degrees from FIG. 5A.

FIG. 5C is a cross-sectional view of the first pump illustrating a state in which the first eccentric shaft has been rotated for 90 degrees from FIG. 5B.

FIG. 5D is a cross-sectional view of the first pump illustrating a state in which the first eccentric shaft has been rotated for 90 degrees from FIG. 5C.

FIG. 6A is a cross-sectional view of the first pipe.

FIG. 6B is a perspective view of the first pipe.

### DESCRIPTION OF THE EMBODIMENTS

A pump unit 1 according to the present embodiment is disposed, for example, in an image forming apparatus for forming an image on a recording material. The image forming apparatus refers to an apparatus for forming an image on a sheet used as a recording medium based on an image information entered from an external PC or an image information read from a document, and which includes a printer, a copying machine, a facsimile, and a multifunction machine. Further, the image forming apparatus may have an auxiliary device such as an optional feeder, an image reading apparatus, or a sheet processing apparatus additionally connected to a main body having an image forming function, and the entire system having such an auxiliary device connected thereto also serves as one kind of an image forming apparatus.

The image forming apparatus includes an image forming unit for forming an image on a recording material, and the image forming unit includes a process cartridge having a developing container for accommodating toner, and a toner cartridge that accommodates toner to be supplied to the developing container. Four process cartridges and four toner cartridges are provided, corresponding to each of the four colors of toner, which are yellow, magenta, cyan, and black. The pump unit 1 according to the present embodiment may convey air selectively to the four toner cartridges, and toner and air are conveyed from the toner cartridge to which air has been sent from the pump unit 1 toward the developing container.

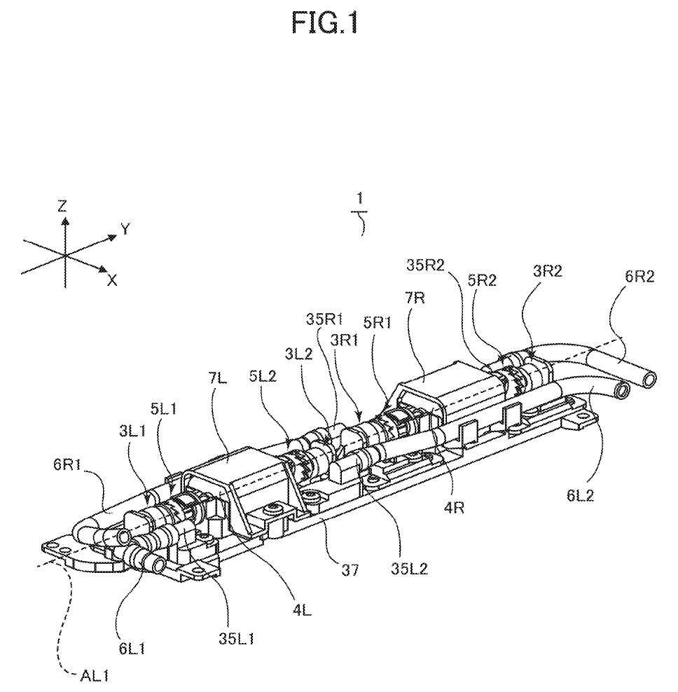

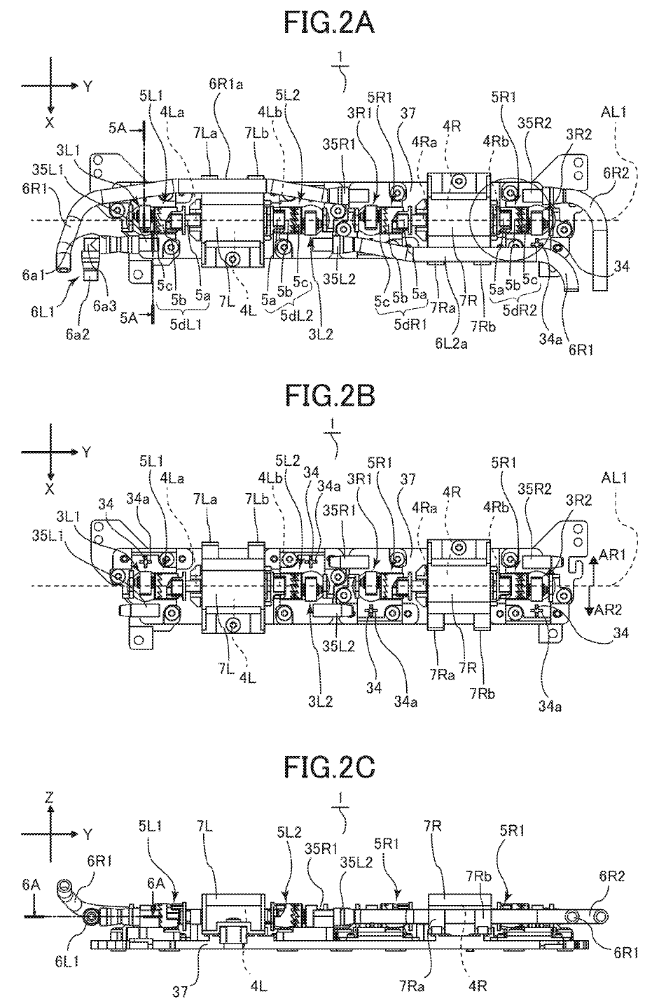

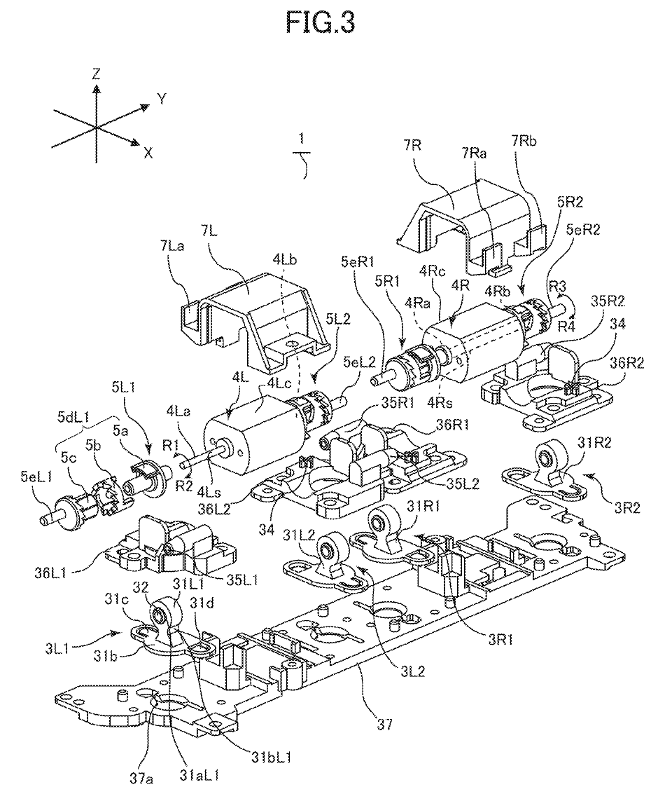

FIG. 1 is a perspective view of the pump unit 1 according to the present embodiment. FIG. 2A is a plan view of the pump unit 1. FIG. 2B is a plan view of the pump unit 1 having a first pipe 6L1, a second pipe 6L2, a third pipe 6R1, and a fourth pipe 6R2 described below removed therefrom. FIG. 2C is a front view of the pump unit 1. FIG. 3 is an exploded perspective view of the pump unit 1.

In the following description, directions X, Y, and Z are defined as illustrated in the drawings. As illustrated in FIG. 1, a short direction of the pump unit 1 is denoted by an X axis, and a direction from a rear side toward a front side of the pump unit 1 is referred to as an X direction. The X direction may also be referred to as a second direction, a forward direction, or a front direction. Further, a downstream side in the X direction of the pump unit 1 may be referred to as a front side, and an upstream side thereof may be referred to as a rear side.

A rotation shaft direction of a first dual shaft motor 4L and a second dual shaft motor 4R of the pump unit 1 is denoted by a Y axis, and a direction from the first dual shaft motor 4L toward the second dual shaft motor 4R is referred to as a Y direction. The Y direction may also be referred to as a direction of a rotational axis AL1, a first direction, an axial direction, or a longitudinal direction. Further, a downstream side in the Y direction of the pump unit 1 may be referred to as a right side, and the upstream side thereof may be referred to as a left side.

An up-down direction of the pump unit 1 is denoted by a Z axis, and a direction from a lower side toward an upper side of the pump unit 1 is referred to as a Z direction. The Z direction may also be referred to as a third direction, an upper direction, a height direction, and a vertical direction. Further, a downstream side in the Z direction of the pump unit 1 may be referred to as an upper side, an upper surface side, and a top surface side, whereas an upstream side thereof may be referred to as a lower side, a lower surface side, and a bottom surface side.

The X axis, the Y axis, and the Z axis are mutually perpendicular to each other. For example, the X axis is perpendicular to the Y axis, and also perpendicular to the Z axis. A plane perpendicular to the X axis may be referred to as a YZ plane, a plane perpendicular to the Y axis may be referred to as a ZX plane, and a plane perpendicular to the Z axis may be referred to as an XY plane. For example, the XY plane is a horizontal plane. The X direction and the Y direction are directions along the horizontal XY plane, that is, the horizontal direction.

The pump unit 1 includes, as illustrated in FIG. 1, the first dual shaft motor 4L, the second dual shaft motor 4R, a first drive transmission portion 5L1, a second drive transmission portion 5L2, a third drive transmission portion 5R1, and a fourth drive transmission portion 5R2. The pump unit 1 includes a first pump 3L1, a second pump 3L2, a third pump 3R1, a fourth pump 3R2, a first holding member 7L, a second holding member 7R, a first pipe 6L1, a second pipe 6L2, a third pipe 6R1, and a fourth pipe 6R2.

The first pump 3L1 conveys, or sends out, air to the first pipe 6L1 by having the drive of the first dual shaft motor 4L transmitted via the first drive transmission portion 5L1. The air sent to the first pipe 6L1 is conveyed, for example, to a toner cartridge accommodating yellow toner attached to the image forming apparatus.

The second pump 3L2 conveys air to the second pipe 6L2 by having the drive of the first dual shaft motor 4L transmitted via the second drive transmission portion 5L2. The air sent to the second pipe 6L2 is conveyed, for example, to a toner cartridge accommodating magenta toner attached to the image forming apparatus.

The third pump 3R1 conveys air to the third pipe 6R1 by having the drive of the second dual shaft motor 4R transmitted via the third drive transmission portion 5R1. The air sent to the third pipe 6R1 is conveyed, for example, to a toner cartridge accommodating cyan toner attached to the image forming apparatus.

The fourth pump 3R2 conveys air to the fourth pipe 6R2 by having the drive of the second dual shaft motor 4R transmitted via the fourth drive transmission portion 5R2. The air sent to the fourth pipe 6R2 is conveyed, for example, to a toner cartridge accommodating black toner attached to the image forming apparatus.

As illustrated in FIGS. 1 to 3, the pump unit 1 serving as an air supply device includes an attachment member 37, and the first dual shaft motor 4L serving as a dual shaft motor is held by the first holding member 7L attached to the attachment member 37. The second dual shaft motor 4R is held by the second holding member 7R attached to the attachment member 37.

The first dual shaft motor 4L serving as a first motor and a motor includes, as illustrated in FIG. 3, a first rotation shaft 4Ls serving as a rotation shaft that extends in the Y direction, and a first housing 4Lc serving as a housing that rotatably supports the first rotation shaft 4Ls. The first rotation shaft 4Ls passes through the first casing 4Lc, and is configured rotatably about a rotational axis AL1 serving as a first rotational axis and a second rotational axis in a first rotation direction R1 and a second rotation direction R2 opposite to the first rotation direction R1. Further, the first rotation shaft 4Ls includes a first projection portion 4La that projects from one side of the first casing 4Lc in the Y direction, and a second projection portion 4Lb that projects from the other side of the first casing 4Lc. The first projection portion 4La serving as a first end portion and a first shaft portion is disposed on one side of the first rotation shaft 4Ls in the Y direction, and a second projection portion 4Lb serving as a second end portion and a second shaft portion is disposed on the other side of the first rotation shaft 4Ls in the Y direction. That is, the first projection portion 4La and the second projection portion 4Lb extend mutually in opposite sides in the Y direction with respect to the first housing 4Lc. The first housing 4Lc, the first pump 3L1, and the second pump 3L2 are arranged in an aligned manner in the Y direction.

The second dual shaft motor 4R serving as a second motor includes a second rotation shaft 4Rs that extends in the Y direction, and a second housing 4Rc that rotatably supports the second rotation shaft 4Rs. The second rotation shaft 4Rs passes through the second housing 4Rc, and is configured rotatably about the rotational axis AL1 in a third rotation direction R3 and a fourth rotation direction R4 opposite to the third rotation direction R3. Further, the second rotation shaft 4Rs includes a third projection portion 4Ra that protrudes from one side of the second housing 4Rc in the Y direction, and a fourth projection portion 4Rb that protrudes from the other side of the second housing 4Rc. The third projection portion 4Ra serving as a third end portion and a third shaft portion is disposed on one side of the second rotation shaft 4Rs in the Y direction, and the fourth projection portion 4Rb serving as a fourth end portion and a fourth shaft portion is disposed on the other side of the second rotation shaft 4Rs in the Y direction. That is, the third projection portion 4Ra and the fourth projection portion 4Rb extend mutually in opposite sides in the Y direction with respect to the second housing 4Rc. The second housing 4Rc, the third pump 3R1, and the fourth pump 3R2 are arranged in an aligned manner in the Y direction.

The first drive transmission portion 5L1 and the second drive transmission portion 5L2 are respectively attached to the first projection portion 4La and the second projection portion 4Lb of the first dual shaft motor 4L. The first drive transmission portion 5L1 serving as a first clutch includes, as illustrated in FIGS. 2A and 3, a first clutch portion 5dL1, and a first eccentric shaft 5eL1 disposed on an output member 5c of the first clutch portion 5dL1. The first clutch portion 5dL1 includes an input member 5a to which drive from the first projection portion 4La is entered, the output member 5c, and a clutch member 5b disposed between the input member 5a and the output member 5c. The clutch member 5b is driven to rotate following the rotation of the input member 5a that rotates together with the first projection portion 4La. The clutch member 5b transmits drive to or shuts off the same from the output member 5c, as described below.

The first eccentric shaft 5eL1 disposed on the output member 5c is provided eccentrically with respect to the first rotation shaft 4Ls, and rotates integrally with the output member 5c that rotates about the first rotation shaft 4Ls. The first eccentric shaft 5eL1 is connected to the first pump 3L1 serving as a first air supply unit, and by the first eccentric shaft 5eL1 rotating in the first rotation direction R1 about the first rotation shaft 4Ls, the first pump 3L1 operates. By the operation of the first pump 3L1, air is discharged through a first discharge portion 35L1 of the first pump 3L1. The first pipe 6L1 is connected to the first discharge portion 35L1, as illustrated in FIGS. 1 and 2A, and air discharged from the first discharge portion 35L1 is passed through the first pipe 6L1 and sent to a desired conveyance destination.

Similarly, the second drive transmission portion 5L2 serving as a second clutch includes, as illustrated in FIGS. 2A and 3, a second clutch portion 5dL2, and a second eccentric shaft 5eL2 disposed on the output member 5c of the second clutch portion 5dL2. The second clutch portion 5dL2 has a similar configuration as the first clutch portion 5dL1, and it is arranged symmetrically in the Y direction with respect to the first housing 4Lc from the first clutch portion 5dL1.

The second eccentric shaft 5eL2 disposed on the output member 5c of the second clutch portion 5dL2 is provided eccentrically with respect to the first rotation shaft 4Ls, and rotates integrally with the output member 5c that rotates about the first rotation shaft 4Ls. The second eccentric shaft 5eL2 is connected to the second pump 3L2 serving as a second air supply unit, and by the second eccentric shaft 5eL2 rotating in the second rotation direction R2 about the first rotation shaft 4Ls, the second pump 3L2 operates. By the operation of the second pump 3L2, air is discharged through a second discharge portion 35L2 of the second pump 3L2. The second pipe 6L2 is connected to the second discharge portion 35L2, as illustrated in FIGS. 1 and 2A, and air discharged through the second discharge portion 35L2 is passed through the second pipe 6L2 and sent to a desired conveyance destination.

The third drive transmission portion 5R1 and the fourth drive transmission portion 5R2 are respectively attached to the third projection portion 4Ra and the fourth projection portion 4Rb of the second dual shaft motor 4R. The third drive transmission portion 5R1 serving as a third clutch includes, as illustrated in FIGS. 2A and 3, a third clutch portion 5dR1, and a third eccentric shaft 5eR1 disposed on the output member 5c of the third clutch portion 5dR1. The third clutch portion 5dR1 adopts a similar configuration as the first clutch portion 5dL1.

The third eccentric shaft 5eR1 disposed on the output member 5c of the third clutch portion 5dR1 is provided eccentrically with respect to the second rotation shaft 4Rs, and rotates integrally with the output member 5c that rotates about the second rotation shaft 4Rs. The third eccentric shaft 5eR1 is connected to the third pump 3R1 serving as a third air supply portion, and by the third eccentric shaft 5eR1 rotating in the third rotation direction R3 about the second rotation shaft 4Rs, the third pump 3R1 operates. By the operation of the third pump 3R1, air is discharged through a third discharge portion 35R1 of the third pump 3R1. The third pipe 6R1 is connected to the third discharge portion 35R1, as illustrated in FIGS. 1 and 2A, and air discharged through the third discharge portion 35R1 is passed through the third pipe 6R1 and sent to a desired conveyance direction.

Similarly, the fourth drive transmission portion 5R2 serving as a fourth clutch includes, as illustrated in FIGS. 2A and 3, a fourth clutch portion 5dR2, and a fourth eccentric shaft 5eR2 disposed on the output member 5c of the fourth clutch portion 5dR2. The fourth clutch portion 5dR2 has a similar configuration as the first clutch portion 5dL1, and is arranged symmetrically in the Y direction with respect to the second casing 4Rc from the third clutch portion 5dR1.

The fourth eccentric shaft 5eR2 disposed on the output member 5c of the fourth clutch portion 5dR2 is provided eccentrically with respect to the second rotation shaft 4Rs, and rotates integrally with the output member 5c that rotates about the second rotation shaft 4Rs. The fourth eccentric shaft 5eR2 is connected to the fourth pump 3R2 serving as a fourth air supply portion, and by the fourth eccentric shaft 5eR2 rotating in the fourth rotation direction R4 about the second rotation shaft 4Rs, the fourth pump 3R2 operates. By the operation of the fourth pump 3R2, air is discharged through a fourth discharge portion 35R2 of the fourth pump 3R2. The fourth pipe 6R2 is connected to the fourth discharge portion 35R2, as illustrated in FIGS. 1 and 2A, and air discharged through the fourth discharge portion 35R2 is passed through the fourth pipe 6R2 and sent to a desired conveyance destination.

### Detailed Configuration of Clutch Portion

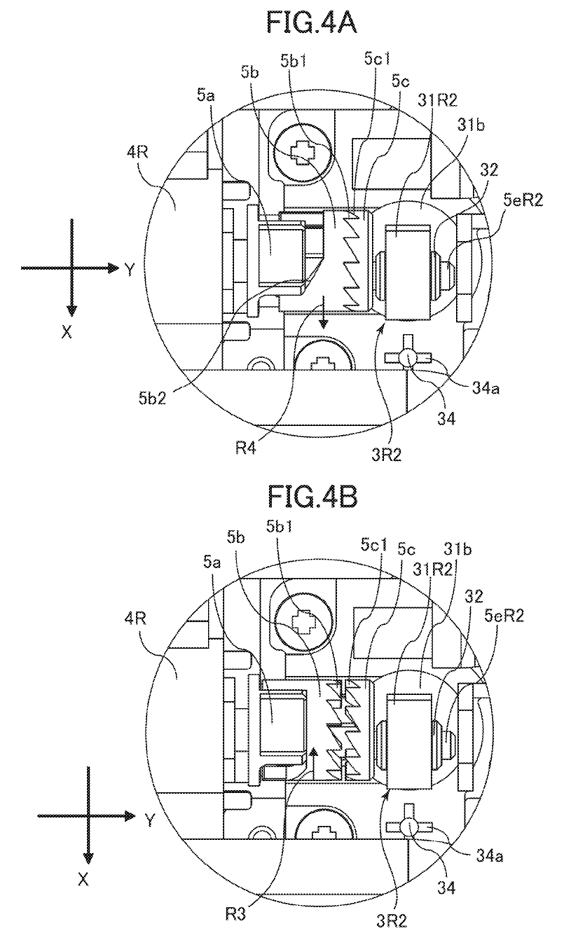

Next, detailed configurations of the respective clutch portions are described with reference to FIGS. 4A and 4B. The respective clutch portions have a similar configuration as described above, such that in the following description, the fourth clutch portion 5dR2 is illustrated as an example. FIGS. 4A and 4B are each an enlarged view of the fourth clutch portion 5dR2 of FIG. 2A. FIG. 4A illustrates the fourth clutch portion 5dR2 in a transmission state, and FIG. 4B illustrates the fourth clutch portion 5dR2 in a non-transmission state. As described below, the fourth clutch portion 5dR2 may be transited between the transmission state and the non-transmission state.

As illustrated in FIGS. 4A and 4B, the fourth clutch portion 5dR2 includes the input member 5a into which drive from the fourth projection portion 4Rb (refer to FIG. 3) is entered, the output member 5c, and the clutch member 5b arranged between the input member 5a and the output member 5c. The clutch member 5b has a toothed surface 5b1 having a saw-tooth shape, and the output member 5c includes a toothed surface 5c1 that faces the toothed surface 5b1 and that is formed to have a saw-tooth shape.

As illustrated in FIGS. 3 and 4A, when the second rotation shaft 4Rs of the second dual shaft motor 4R rotates in the fourth rotation direction R4, the input member 5a fixed to the fourth projection portion 4Rb of the second rotation shaft 4Rs also rotates in the fourth rotation direction R4. Then, the clutch member 5b also rotates in the fourth rotation direction R4 following the rotation of the input member 5a. In this state, the input member 5a presses an inclined surface 5b2 of the clutch member 5b, such that the clutch member 5b moves in the Y direction, and the toothed surface 5b1 of the clutch member 5b is meshed with the toothed surface 5c1 of the output member 5c. Thereby, the fourth clutch portion 5dR2 is in a transmission state in which the drive of the fourth projection portion 4Rb is transmitted to the fourth pump 3R2. That is, the drive of the fourth projection portion 4Rb of the second rotation shaft 4Rs is transmitted through the input member 5a, the clutch member 5b, and the output member 5c to the fourth eccentric shaft 5eR2, and the fourth pump 3R2 is operated by the rotation of the fourth eccentric shaft 5eR2.

Further, as illustrated in FIGS. 3 and 4B, in a state where the second rotation shaft 4Rs of the second dual shaft motor 4R rotates in the third rotation direction R3, the input member 5a fixed to the fourth projection portion 4Rb of the second rotation shaft 4Rs also rotates in the third rotation direction R3. Then, the clutch member 5b also rotates in the third rotation direction R3 following the rotation of the input member 5a. In this state, the input member 5a does not press the inclined surface 5b2 of the clutch member 5b, such that the clutch member 5b does not move in the Y direction, and the toothed surface 5b1 of the clutch member 5b remains separated from the toothed surface 5c1 of the output member 5c. Even if the toothed surfaces 5b1 and 5c1 are abutted against each other, due to their saw-tooth shapes, the toothed surfaces 5b1 and 5c1 will not mesh with each other.

Thereby, the fourth clutch portion 5dR2 will be in a non-transmission state in which the drive of the fourth projection portion 4Rb is not transmitted to the fourth pump 3R2. That is, the rotation of the third rotation direction R3 of the clutch member 5b will not be transmitted to the output member 5c, and the fourth pump 3R2 will not operate.

As described, according to the direction of rotation of the second rotation shaft 4Rs of the second dual shaft motor 4R, the fourth clutch portion 5dR2 is switched between the transmission state and the non-transmission state, by which whether the fourth pump 3R2 is operated or not is determined. Such a configuration is also adopted in the first pump 3L1, the second pump 3L2, and the third pump 3R1.

That is, as illustrated in FIG. 3, when the first rotation shaft 4Ls of the first dual shaft motor 4L rotates in the first rotation direction R1, the first clutch portion 5dL1 will be in a transmission state and the second clutch portion 5dL2 will be in a non-transmission state. In other words, the first drive transmission portion 5L1 will be in a transmission state in which drive force is transmitted from the first projection portion 4La to the first pump 3L1, and the second drive transmission portion 5L2 will be in a non-transmission state in which drive force is not transmitted from the second projection portion 4Lb to the second pump 3L2. Therefore, the first pump 3L1 will be driven by being transmitted a first driving force from the first projection portion 4La of the first rotation shaft 4Ls and the second pump 3L2 will not operate. Further, when the first rotation shaft 4Ls of the first dual shaft motor 4L rotates in the second rotation direction R2, the first clutch portion 5dL1 will be in a non-transmission state and the second clutch portion 5dL2 will be in a transmission state. In other words, the first drive transmission portion 5L1 will be in a non-transmission state in which drive force is not transmitted from the first projection portion 4La to the first pump 3L1, and the second drive transmission portion 5L2 will be in a transmission state in which drive force is transmitted from the second projection portion 4Lb to the second pump 3L2. Therefore, the first pump 3L1 will not operate and the second pump 3L2 will be driven by being transmitted a second driving force from the second projection portion 4Ra of the first rotation shaft 4Ls.

Further, when a second rotation shaft 4Rs of a second dual shaft motor 4R rotates in the third rotation direction R3, the third clutch portion 5dR1 will be in a transmission state and the fourth clutch portion 5dR2 will be in a non-transmission state. In other words, the third drive transmission portion 5R1 will be in a transmission state in which the drive force is transmitted from the third projection portion 4Ra to the third pump 3R1, and the fourth drive transmission portion 5R2 will be in a non-transmission state in which the drive force is not transmitted from the fourth projection portion 4Rb to the fourth pump 3R2. Therefore, the third pump 3R1 will be driven by being transmitted a third driving force from the third projection portion 4Ra of the second rotation shaft 4Rs and the fourth pump 3R2 will not be driven. Further, as described above, when the second rotation shaft 4Rs of the second dual shaft motor 4R rotates in the fourth rotation direction R4, the third clutch portion 5dR1 will be in a non-transmission state and the fourth clutch portion 5dR2 will be in a transmission state. In other words, the third drive transmission portion 5R1 will be in a non-transmission state in which the drive force is not transmitted from the third projection portion 4Ra to the third pump 3R1, and the fourth drive transmission portion 5R2 will be in a transmission state in which the drive force is transmitted from the fourth projection portion 4Rb to the fourth pump 3R2. Therefore, the third pump 3R1 will not be driven and the fourth pump 3R2 will be driven by being transmitted a fourth driving force from the fourth projection portion 4Rb of the second rotation shaft 4Rs.

Transmission states of the first clutch portion 5dL1, the second clutch portion 5dL2, the third clutch portion 5dR1, and the fourth clutch portion 5dR2 may also be referred to respectively as a first transmission state, a second transmission state, a third transmission state, and a fourth transmission state. The states of the first drive transmission portion 5L1, the second drive transmission portion 5L2, the third drive transmission portion 5R1, and the fourth drive transmission portion 5R2 at this time may also be referred to respectively as the first transmission state, the second transmission state, the third transmission state, and the fourth transmission state.

The non-transmission states of the first clutch portion 5dL1, the second clutch portion 5dL2, the third clutch portion 5dR1, and the fourth clutch portion 5dR2 may also be referred to respectively as a first non-transmission state, a second non-transmission state, a third non-transmission state, and a fourth non-transmission state. Further, the states of the first drive transmission portion 5L1, the second drive transmission portion 5L2, the third drive transmission portion 5R1, and the fourth drive transmission portion 5R2 at this time may also be referred to respectively as the first non-transmission state, the second non-transmission state, the third non-transmission state, and the fourth non-transmission state.

The configurations of the respective clutch portions described above are mere examples, and the present technique is not limited thereto. That is, the clutch portion may adopt other configurations as long as the cutoff or transmission of drive to the output shaft is changed. For example, other clutches such as an electromagnetic clutch that may be switched between a transmission state where drive force is transmitted and a non-transmission state where drive force is not transmitted regardless of the direction of rotation of the respective rotation shafts of the first dual shaft motor 4L and the second dual shaft motor 4R may be adopted instead of the respective clutch portions.

### Detailed Configuration of Pump

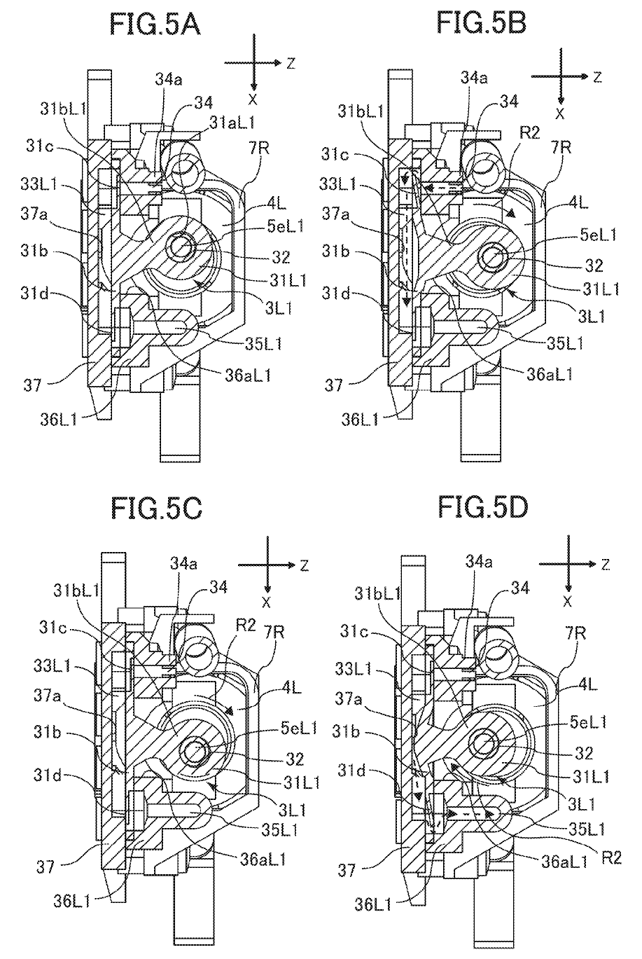

Next, detailed configurations of the respective pumps will be described with reference to FIGS. 3 and 5A to 5D. The respective pumps adopt similar configurations as described above, such that in the following description, the first pump 3L1 is taken as an example and illustrated. FIG. 5A is a cross-sectional view of a 5A-5A cross-section of FIG. 2. FIG. 5B is a cross-sectional view of the first pump 3L1 illustrating a state in which the first eccentric shaft 5eL1 has been rotated for 90 degrees from FIG. 5A. FIG. 5C is a cross-sectional view of the first pump 3L1 illustrating a state in which the first eccentric shaft 5eL1 has been rotated for 90 degrees from FIG. 5B. FIG. 5D is a cross-sectional view of the first pump 3L1 illustrating a state in which the first eccentric shaft 5eL1 has been rotated for 90 degrees from FIG. 5C.

As illustrated in FIGS. 3 and 5A, the first pump 3L1 includes a base member 36L1 fixed to the attachment member 37, and a diaphragm member 31L1 nipped by the attachment member 37 and the base member 36L1. The base member 36L1 includes an intake portion 34 serving as an air intake through which air is taken in, a discharge portion 35L1 serving as an air discharge port through which air is discharged, and a hole portion 36aL1. As illustrated in FIGS. 2B and 5A, the intake portion 34 is provided with an intake port not shown through which air is taken in, and a rib 34a that extends in the Z direction from the circumference of the intake port. Thereby, even if the member such as the third pipe 6R1 arranged in the vicinity of the intake portion 34 is sucked together with air toward the intake portion 34, the member abuts against the rib 34a, such that the blocking of the intake portion 34 by the member may be suppressed. In the X direction orthogonal to the Y direction, one side thereof with respect to the rotational axis AL1 is referred to as a first area AR1, and the other side thereof with respect to the rotational axis AL1 is referred to as a second area AR2. That is, the first area AR1 and the second area AR2 may be disposed mutually on opposite sides of the rotational axis AL1 in the X direction. In this state, the intake portion 34 is disposed in the first area AR1, and the discharge portion 35L1 is disposed in the second area AR2.

The diaphragm member 31L1 includes a flat surface portion 31b, and a pillar portion 31bL1 that extends in the Z direction from the flat surface portion 31b. When the base member 36L1 and the diaphragm member 31L1 are attached to the attachment member 37, the pillar portion 31bL1 of the diaphragm member 31L1 passes through the hole portion 36aL1 of the base member 36L1. An upstream valve portion 31c and a downstream valve portion 31d are respectively disposed on an upstream end portion and a downstream end portion in the X direction of the flat surface portion 31b. A shaft hole portion 31aL1 to which the first eccentric shaft 5eL1 is inserted via a bearing 32 is disposed on the pillar portion 31bL1. In other words, the first eccentric shaft 5eL1 is supported rotatably in the shaft hole portion 31aL1 via the bearing 32.

A recess portion 37a is disposed on the attachment member 37 at a position corresponding to the flat surface portion 31b of the diaphragm member 31L1. In a state where the diaphragm member 31L1 and the base member 36L1 are attached to the attachment member 37, a volume variation portion 33L1 is formed by the recess portion 37a of the attachment member 37 and the flat surface portion 31b of the diaphragm member 31L1. The volume variation portion 33L1 is a space surrounded by the recess portion 37a and the flat surface portion 31b, and the first pump 3L1 is a diaphragm pump capable of varying the capacity of the volume variation portion 33L1, which is the internal space of the first pump 3L1.

As illustrated in FIG. 5A, a state in which the flat surface portion 31b of the diaphragm member 31L1 is extended straight in the X direction is set as a normal state. By the first eccentric shaft 5eL1 rotating about the first rotation shaft 4Ls, the flat surface portion 31b of the diaphragm member 31L1 is displaced via the pillar portion 31bL1. As illustrated in FIG. 5B, from a state in which the diaphragm member 31L1 is in a normal state, when the first eccentric shaft 5eL1 is rotated for 90 degrees in the second rotation direction R2, the flat surface portion 31b of the diaphragm member 31L1 is displaced in a direction separating from the recess portion 37a, and the volume of the volume variation portion 33L1 is increased. In this state, the upstream valve portion 31c opens a path for air between the intake portion 34 and the volume variation portion 33L1, and allows air to enter the volume variation portion 33L1. Meanwhile, the downstream valve portion 31d shuts the path for air between the discharge portion 35L1 and the volume variation portion 33L1, and regulates air from flowing in a reverse direction to the volume variation portion 33L1.

As illustrated in FIG. 5C, when the first eccentric shaft 5eL1 is rotated for 90 degrees from the state illustrated in FIG. 5B to the second rotation direction R2, the diaphragm member 31L1 returns to the normal state, and the volume of the volume variation portion 33L1 is reduced. Further, as illustrated in FIG. 5D, when the first eccentric shaft 5eL1 is rotated for 90 degrees from the state illustrated in FIG. 5C to the second rotation direction R2, the flat surface portion 31b of the diaphragm member 31L1 is displaced to a direction approaching the recess portion 37a, and the volume of the volume variation portion 33L1 is reduced.

As described, in a state where the volume of the volume variation portion 33L1 is reduced, the upstream valve portion 31c shuts the path of air between the intake portion 34 and the volume variation portion 33L1, and regulates air from entering the volume variation portion 33L1. Meanwhile, the downstream valve portion 31d opens a path of air between the discharge portion 35L1 and the volume variation portion 33L1, and allows discharge of air from the volume variation portion 33L1. When the eccentric shaft 5eL1 is rotated for 90 degrees in the second rotation direction R2 from the state illustrated in FIG. 5D, the diaphragm member 31L1 returns to the normal state and returns to the state illustrated in FIG. 5A.

The diaphragm member 31L1 of the first pump 3L1 moves in reciprocating motion in the Z direction accompanying the rotation of the first eccentric shaft 5eL1, as illustrated in FIGS. 5A to 5D. Thereby, the first pump 3L1 functions as a diaphragm-type pump that takes in air through the intake portion 34 and discharges air through the discharge portion 35L1.

The pump unit 1 includes the second pump 3L2, the third pump 3R1, and the fourth pump 3R2 that have a similar configuration as the first pump 3L1. By the first rotation shaft 4Ls of the first dual shaft motor 4L rotating in a first rotation direction R1, drive is transmitted via the first drive transmission portion 5L1 to the first eccentric shaft 5eL1. In this state, by the second drive transmission portion 5L2 transiting to the non-transmission state, the rotation in the first rotation direction R1 of the first rotation shaft 4Ls is not transmitted to the second eccentric shaft 5eL2. Thereby, the first pump 3L1 will operate and the second pump 3L2 will not operate.

By the first rotation shaft 4Ls of the first dual shaft motor 4L rotating in the second rotation direction R2, drive is transmitted via the second drive transmission portion 5L2 to the second eccentric shaft 5eL2. In this state, by the first drive transmission portion 5L1 transiting to the non-transmission state, the rotation of the second rotation direction R2 of the first rotation shaft 4Ls is not transmitted to the first eccentric shaft 5eL1. Thereby, the second pump 3L2 will operate and the first pump 3L1 will not operate.

By the second rotation shaft 4Rs of the second dual shaft motor 4R rotating in the third rotation direction R3, drive is transmitted to the third eccentric shaft 5eR1 via the third drive transmission portion 5R1. In this state, by the fourth drive transmission portion 5R2 transiting to the non-transmission state, the rotation of the second rotation shaft 4Rs in the third rotation direction R3 is not transmitted to the fourth eccentric shaft 5eR2. Thereby, the third pump 3R1 will operate and the fourth pump 3R2 will not operate.

Further, by the second rotation shaft 4Rs of the second dual shaft motor 4R rotating in the fourth rotation direction R4, drive is transmitted to the fourth eccentric shaft 5eR2 via the fourth drive transmission portion 5R2. In this state, by the third drive transmission portion 5R1 transiting to the non-transmission state, the rotation of the second rotation shaft 4Rs in the fourth rotation direction R4 is not transmitted to the fourth eccentric shaft 5eR2. Thereby, the fourth pump 3R2 will operate and the third pump 3R1 will not operate.

As described, the pump unit 1 may cause arbitrary pumps (3L1, 3L2, 3R1, and 3R2) to be operated by switching the rotation directions of the rotation shafts (4Ls and 4Rs) of the two motors, which are the first dual shaft motor 4L and the second dual shaft motor 4R.

### PUMP UNIT LAYOUT

Next, a layout of the pump unit 1 will be described in detail. As illustrated in FIGS. 1 to 3, the first rotation shaft 4Ls of the first dual shaft motor 4L and the second rotation shaft 4Rs of the second dual shaft motor 4R are arranged coaxially. That is, the first rotation shaft 4Ls and the second rotation shaft 4Rs are arranged on the same rotational axis AL1, as illustrated in FIG. 1. Therefore, the size of the pump unit 1 in the X direction and the Z direction may be downsized.

The first dual shaft motor 4L including the first housing 4Lc, the first clutch portion 5dL1, the first eccentric shaft 5eL1, the second clutch portion 5dL2, and the second eccentric shaft 5eL2 are aligned in the Y direction. Similarly, the second dual shaft motor 4R including the second housing 4Rc, the third clutch portion 5dR1, the third eccentric shaft 5eR1, the fourth clutch portion 5dR2, and the fourth eccentric shaft 5eR2 are aligned in the Y direction. Therefore, the size of the pump unit 1 in the X direction and the Z direction may be downsized.

As illustrated in FIGS. 2A to 2C, the second discharge portion 35L2 and the third discharge portion 35R1 are arranged such that at least a portion thereof is mutually overlapped in the X direction, which is an orthogonal direction orthogonal to the Y direction. The second discharge portion 35L2 and the third discharge portion 35R1 are arranged between the two motors, which are the first dual shaft motor 4L and the second dual shaft motor 4R, in the Y direction. By adopting this arrangement, the size of the pump unit 1 in the Y direction may be downsized. The arrangements of the second discharge portion 35L2 and the third discharge portion 35R1 are not limited to the above-described arrangement.

Further, as illustrated in FIGS. 1 to 3, the second pipe 6L2 and the third pipe 6R1 are respectively connected to the second discharge portion 35L2 and the third discharge portion 35R1. The second pipe 6L2 is held by the second holding member 7R holding the second housing 4Rc of the second dual shaft motor 4R, and the third pipe 6R1 is held by the first holding member 7L holding the first housing 4Lc of the first dual shaft motor 4L.

As illustrated in FIG. 2A, the second pipe 6L2 is arranged such that a portion 6L2a whose position in the Y direction overlaps with the second housing 4Rc extends in parallel in the Y direction. The third pipe 6R1 is arranged such that a portion 6R1a whose position in the Y direction overlaps with the first housing 4Lc extends in parallel in the Y direction. The portion 6L2a described above is held by hook portions 7Ra and 7Rb of the second holding member 7R, as illustrated in FIGS. 2A to 2C and 3, and the portion 6R1a is held by hook portions 7La and 7Lb of the first holding member 7L. Further, the first discharge portion 35L1 is arranged on an opposite side as the second housing 4Rc with respect to the first housing 4Lc, and the first pipe 6L1 connected to the first discharge portion 35L1 extends to separate from the first housing 4Lc in the Y direction. The fourth discharge portion 35R2 is arranged on an opposite side as the first housing 4Lc with respect to the second housing 4Rc, and the fourth pipe 6R2 connected to the fourth discharge portion 35R2 extends to separate from the second housing 4Rc in the Y direction. By adopting such arrangement, the size of the pump unit 1 in the X direction and the Z direction may be downsized.

According further to the present embodiment, the second pipe 6L2, the third pipe 6R1, and the fourth pipe 6R2 are composed of a flexible member having flexibility against deformations such as bends and expansion/contraction. Examples of a flexible member may include resin material such as plastic having flexibility, rubber, and cloth. The second pipe 6L2, the third pipe 6R1, and the fourth pipe 6R2 are formed in a tube shape, such that if the pipes are curved by an angle close to a right angle, the pipes may be bent and the paths in the interior of the pipe may be blocked. Therefore, the second pipe 6L2, the third pipe 6R1, and the fourth pipe 6R2 are configured to gradually change directions toward the downstream direction in the X direction, as illustrated in FIG. 1.

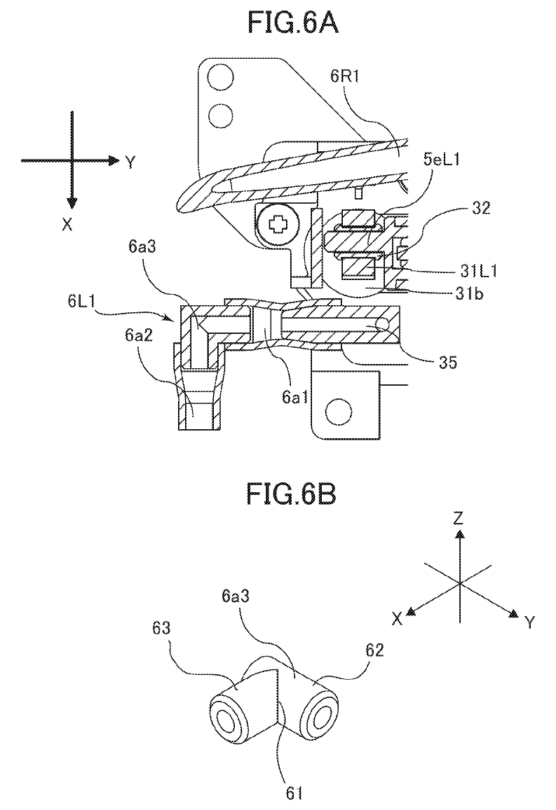

Meanwhile, it is desirable that the first pipe 6L1 is bent by an angle close to a right angle, since space is limited. Therefore, the first pipe 6L1 is composed of a first member 6a1 that extends in the Y direction, a second member 6a2 that extends in the X direction, and a third member 6a3 that connects the first member 6a1 and the second member 6a2, as illustrated in FIGS. 2A, 6A, and 6B. The first member 6a1 is connected to the first discharge portion 35L1. FIG. 6A is a cross-sectional view of the first pipe 6L1, and FIG. 6B is a perspective view of the first pipe 6L1. Further, FIG. 6A is a 6A-6A cross-section of FIG. 2C.

The first member 6a1 and the second member 6a2 are each composed of a resin material having flexibility, and extend in mutually different directions. The third member 6a3 includes a bent portion 61 and has a higher stiffness than the stiffnesses of the first member 6a1 and the second member 6a2. Further, the third member 6a3 includes a first connection portion 62 that extends in the Y direction and is connected to the first member 6a1, and a second connection portion 63 that extends in the X direction and is connected to the second member 6a2, wherein the bent portion 61 is formed between the first connection portion 62 and the second connection portion 63.

By configuring the first pipe 6L1 as described above, the first pipe 6L1 may be bent by an angle close to a right angle without blocking the path on the inner side of the first pipe 6L1. Further, the degree of freedom of arrangement of the first pipe 6L1 may be improved.

The first pipe 6L1, the second pipe 6L2, the third pipe 6R1, and the fourth pipe 6R2 are not necessarily formed of flexible members, and may be composed of other materials, such as metal. Further, the second pipe 6L2, the third pipe 6R1, and the fourth pipe 6R2 may include a bent portion, similar to the first pipe 6L1.

By configuring the pump unit 1 as described above, a new embodiment of a pump unit may be provided. Further, the pump unit 1 may be downsized.

### Other Embodiments

According to the present embodiment, the first pump 3L1 is configured to be operated when the first rotation shaft 4Ls is rotated in the first rotation direction R1, but the present technique is not limited thereto. Which pump is to be operated when the first rotation shaft 4Ls or the second rotation shaft 4Rs is rotated in the respective directions may be set arbitrarily.

According to the present embodiment, the first dual shaft motor 4L, the first clutch portion 5dL1, the first eccentric shaft 5eL1, the second clutch portion 5dL2, and the second eccentric shaft 5eL2 are arranged in an aligned manner in the Y direction, but the present technique is not limited thereto. For example, the first dual shaft motor 4L, the first clutch portion 5dL1, the first eccentric shaft 5eL1, the second clutch portion 5dL2, and the second eccentric shaft 5eL2 may be arranged in an aligned manner in either the X direction or the Z direction.

According to the present embodiment, the first rotation shaft 4Ls of the first dual shaft motor 4L and the second rotation shaft 4Rs of the second dual shaft motor 4R are arranged coaxially, but the present technique is not limited thereto. For example, the first rotation shaft 4Ls and the second rotation shaft 4Rs are not necessarily arranged coaxially, and may be somewhat displaced in the X direction or the Z direction

According to the present embodiment, the second pipe 6L2 is arranged such that the portion 6L2a whose position in the Y direction overlaps with the second housing 4Rc extends in parallel in the Y direction. Further, the third pipe 6R1 is arranged such that the portion 6R1a whose position in the Y direction overlaps with the first housing 4Lc extends in parallel in the Y direction. However, the pump unit 1 is not limited to this arrangement, and the portions 6L2a and 6R1a are not necessarily arranged in parallel in the Y direction. Further, the first pipe 6L1 and the fourth pipe 6R2 may be arranged to respectively hold the first housing 4Lc and the second housing 4Rc. That is, the first pipe 6L1, the second pipe 6L2, the third pipe 6R1, and the fourth pipe 6R2 are not necessarily arranged as described in the present embodiment, and arrangements thereof may be varied arbitrarily. The second pipe 6L2 and the third pipe 6R1 are each not necessarily held by the second housing 4Rc and the first housing 4Lc.

The respective pumps described above are not limited to the diaphragm-type pumps, and they may be composed of reciprocating pumps, such as piston pumps and plunger pumps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-027891, filed February 27, 2024, which is hereby incorporated by reference herein in its entirety.

What is claimed is:

1. A pump unit comprising:
a motor including a rotation shaft which is configured to be rotated about a rotational axis in a first rotation direction and in a second rotation direction opposite to the first rotation direction, and from which a first driving force and a second driving force are output;
a first pump and a second pump that are configured to send out air;
a first drive transmission portion configured to be transitioned between a first transmission state in which the first driving force is transmitted to the first pump and a first non-transmission state in which the first driving force is not transmitted to the first pump; and
a second drive transmission portion configured to be transitioned between a second transmission state in which the second driving force is transmitted to the second pump and a second non-transmission state in which the second driving force is not transmitted to the second pump,
wherein the first drive transmission portion is configured to drive the first pump by being transitioned to the first transmission state when the rotation shaft is rotated in the first rotation direction, and configured not to drive the first pump by being transitioned to the first non-transmission state when the rotation shaft is rotated in the second rotation direction, and
wherein the second drive transmission portion is configured not to drive the second pump by being transitioned to the second non-transmission state when the rotation shaft is rotated in the first rotation direction, and configured to drive the second pump by being transitioned to the second transmission state when the rotation shaft is rotated in the second rotation direction.

2. The pump unit according to claim 1, wherein the first drive transmission portion includes:
a first clutch portion to which the first driving force from the rotation shaft is input; and
a first eccentric shaft connected to the first pump and arranged eccentrically with respect to the rotation shaft,
wherein the second drive transmission portion includes:
a second clutch portion to which the second driving force from the rotation shaft is input; and
a second eccentric shaft connected to the second pump and arranged eccentrically with respect to the rotation shaft,
wherein the first clutch portion transmits the first driving force to the first eccentric shaft when the rotation shaft is rotated in the first rotation direction, and the first clutch portion does not transmit the first driving force to the first eccentric shaft when the rotation shaft is rotated in the second rotation direction, and
wherein the second clutch portion does not transmit the second driving force to the second eccentric shaft when the rotation shaft is rotated in the first rotation direction, and the second clutch portion transmits the second driving force to the second eccentric shaft when the rotation shaft is rotated in the second rotation direction.

3. The pump unit according to claim 2, wherein the motor, the first clutch portion, the first eccentric shaft, the second clutch portion, and the second eccentric shaft are aligned in a direction of the rotational axis.

4. The pump unit according to claim 1, wherein the first pump and the second pump are each a diaphragm pump.

5. The pump unit according to claim 1, wherein the rotation shaft, the motor, and the rotational axis are each a first rotation shaft, a first motor, and a first rotational axis, respectively,
wherein the pump unit further includes:
a second motor including a second rotation shaft which is configured to be rotated about a second rotational axis in a third rotation direction and in a fourth rotation direction opposite to the third rotation direction, and from which a third driving force and a fourth driving force are output, the second rotational axis extending in a direction parallel to the first rotational axis;
a third pump and a fourth pump that are configured to send out air;
a third drive transmission portion configured to be transitioned between a third transmission state in which a third driving force is transmitted to the third pump and a third non-transmission state in which the third driving force is not transmitted to the third pump; and
a fourth drive transmission portion configured to be transitioned between a fourth transmission state in which a fourth driving force is transmitted to the fourth pump and a fourth non-transmission state in which the fourth driving force is not transmitted to the fourth pump,
wherein the third drive transmission portion is configured to drive the third pump by being transitioned to the third transmission state when the second rotation shaft is rotated in the third rotation direction, and configured not to drive the third pump by being transitioned to the third non-transmission state when the second rotation shaft is rotated in the fourth rotation direction, and
wherein the fourth drive transmission portion is configured not to drive the fourth pump by being transitioned to the fourth non-transmission state when the second rotation shaft is rotated in the third rotation direction, and configured to drive the fourth pump by being transitioned to the fourth transmission state when the second rotation shaft is rotated in the fourth rotation direction.

6. The pump unit according to claim 5, wherein the first pump, the second pump, the third pump, and the fourth pump respectively include a first discharge portion, a second discharge portion, a third discharge portion and a fourth discharge portion, each of which discharges air,
wherein the pump unit further includes:
a first pipe connected to the first discharge portion and through which air discharged from the first discharge portion passes;
a second pipe connected to the second discharge portion and through which air discharged from the second discharge portion passes;
a third pipe connected to the third discharge portion and through which air discharged from the third discharge portion passes; and
a fourth pipe connected to the fourth discharge portion and through which air discharged from the fourth discharge portion passes,
wherein the first motor includes a first housing configured to support the first rotation shaft rotatably,
wherein the second motor includes a second housing configured to support the second rotation shaft rotatably,
wherein the second pipe is arranged such that a portion, of the second pipe, whose position in a direction of the first rotational axis overlaps with the second housing extends in parallel with the direction of the first rotational axis, and
wherein the third pipe is arranged such that a portion, of the third pipe, whose position in the direction of the first rotational axis overlaps with the first housing extends in parallel with the direction of the first rotational axis.

7. The pump unit according to claim 6, further comprising:
a first holding member configured to hold the first motor and the third pipe; and
a second holding member configured to hold the second motor and the second pipe.

8. The pump unit according to claim 6, wherein the second discharge portion and the third discharge portion are arranged such that at least a portion of the second discharge portion and a portion of the third discharge portion are overlapped with each other when viewed in an orthogonal direction orthogonal to the direction of the first rotational axis.

9. The pump unit according to claim 6, wherein the second discharge portion and the third discharge portion are arranged between the first housing and the second housing in the direction of the first rotational axis.

10. The pump unit according to claim 6, wherein the first discharge portion is arranged on a side opposite to the second housing with respect to the first housing in the direction of the first rotational axis, and
wherein the fourth discharge portion is arranged on a side opposite to the first housing with respect to the second housing in the direction of the first rotational axis.

11. The pump unit according to claim 6, wherein the first discharge portion, the second discharge portion, the third discharge portion and the fourth discharge portion extend in the direction of the first rotational axis.

12. The pump unit according to claim 6, wherein at least one of the second pipe, the third pipe and the fourth pipe includes a flexible resin material.

13. The pump unit according to claim 6, wherein the first pipe includes:
a first member and a second member that are each composed of a resin material having flexibility, and that extend in mutually different directions; and
a third member including a bent portion and connecting the first member and the second member, and
wherein a stiffness of the third member is higher than a stiffness of each of the first member and the second member.

14. The pump unit according to claim 5, wherein the first pump, the second pump, the third pump, and the fourth pump each include an intake portion through which air is taken in, and
wherein the intake portion includes a rib arranged on a circumference of an intake port through which air is taken in.

15. An air supply device for conveying toner in an image forming apparatus, comprising:
a motor including:
(i) a housing; and
(ii) a rotation shaft which is rotatable about a rotational axis in a first rotation direction and a second rotation direction opposite to the first rotation direction, and from which a first driving force and a second driving force are output;
first and second air supply units configured to supply air;
a first clutch configured to transmit the first driving force to the first air supply unit when the rotation shaft of the motor is rotated in the first rotation direction, and configured not to transmit the first driving force to the first air supply unit when the rotation shaft of the motor is rotated in the second rotation direction; and
a second clutch configured to transmit the second driving force to the second air supply unit when the rotation shaft of the motor is rotated in the second rotation direction, and configured not to transmit the second driving force to the second air supply unit when the rotation shaft of the motor is rotated in the first rotation direction.

16. The air supply device according to claim 15, wherein the housing, the first clutch and the second clutch are aligned in a direction of the rotational axis.

17. The air supply device according to claim 15, wherein the housing and the first and second air supply units are aligned in a direction of the rotational axis.

18. The air supply device according to claim 15, wherein the first air supply unit includes a first air intake and a first air discharge port which are provided in a first area and a second area, respectively, the first area and the second area being located on opposite sides with respect to the rotational axis in a direction orthogonal to the rotational axis.

19. The air supply device according to claim 15, wherein the motor, the housing, the rotation shaft, and the rotational axis are a first motor, a first housing, a first rotation shaft, and a first rotational axis, respectively, and
wherein the air supply device further includes:
a second motor including:
(i) a second housing; and
(ii) a second rotation shaft which is rotatable about a second rotational axis in a third rotation direction and a fourth rotation direction opposite to the third rotation direction, and from which a third driving force and a fourth driving force are output;
third and fourth air supply units configured to supply air;
a third clutch configured to transmit the third driving force to the third air supply unit when the second rotation shaft of the second motor is rotated in the third rotation direction, and configured not to transmit the third driving force to the third air supply unit when the second rotation shaft of the second motor is rotated in the fourth rotation direction; and
a fourth clutch configured to transmit the fourth driving force to the fourth air supply unit when the second rotation shaft of the second motor is rotated in the fourth rotation direction, and configured not to transmit the fourth driving force to the fourth air supply unit when the second rotation shaft of the second motor is rotated in the third rotation direction.

20. An air supply device for conveying toner in an image forming apparatus, comprising:
a motor including:
(i) a housing; and
(ii) a rotation shaft which is rotatable about a rotational axis in a first rotation direction and a second rotation direction opposite to the first rotation direction, and from which a first driving force and a second driving force are output;
first and second air supply units configured to supply air;
a first clutch configured to be transitioned between a first transmission state in which the first driving force is transmitted to the first air supply unit, and a first non-transmission state in which the first driving force is not transmitted to the first air supply unit; and
a second clutch configured to be transitioned between a second transmission state in which the second driving force is transmitted to the second air supply unit, and a second non-transmission state in which the second driving force is not transmitted to the second air supply unit.
